(19) United States
(12) Patent Application Publication
(10) Pub. No.: US 2004/0086267 A1
(43) Pub. Date: May 6, 2004

(54) Image reproduction system

(75) Inventors: Masakazu Ogawa, Shinjuku-ku (JP); Michitoshi Suzuki, Shinjuku-ku (JP); Shinya Taguchi, Shinjuku-ku (JP); Shunsuke Nagatani, Shinjuku-ku (JP); Eisuke Kanno, Shinjuku-ku (JP); Yutaka Egawa, Shinjuku-ku (JP); Nobuyuki Yamazoe, Shinjuku-ku (JP)

Correspondence Address: OLIFF & BERRIDGE, PLC, P.O. BOX 19928, ALEXANDRIA, VA, 22320, US

(73) Assignee: FUJI XEROX CO., LTD, Tokyo (JP)

(21) Appl. No.: 10/661,489

(22) Filed: Sep. 15, 2003

(30) Foreign Application Priority Data
Sep. 19, 2002 (JP) 2002-272499

(51) Int. Cl. H04N 5/781

(52) U.S. Cl. 386/95; 386/125

(57) ABSTRACT

Static image data of materials used in videoed lectures and the like is presented to browsing users synchronously with video data. As video data is reproduced by a video player of a browsing client, reproduction time positions of the video data are obtained in an image synchronous function part, static image data associated in advance with the reproduction time positions is requested from a delivery server holding the video data and static image data associated with the video data, and the static image data is provided from the delivery server and displayed in an image display part.

### BACKGROUND OF THE INVENTION

1. Field of the Invention

The present invention relates to a system that synchronously reproduces video data (moving image data) and static image data.

2. Description of the Related Art

Services for delivering various contents to browsing clients such as personal computers and mobile terminals are widely provided as services for specific areas or global areas.

There are different types of systems performing such contents delivery. With the development of network communication technology, contents data containing video data is also delivered.

In these contents delivery systems, various contents data is registered in a delivery server, and when browsing clients access the delivery server to select and request desired contents, in response to it, the delivery server provides the contents data to the browsing clients.

In systems delivering video data, to ease selection of contents, the video data is associated with contents records (meta-records) including contents title, keyword for selecting contents, category information for selecting contents, contents author information, and the like, providing convenience for users who view contents by use of the browsing clients.

There is delivered a wide variety of video data from amusements such as movies to education, lecture, and presentation. Especially for video of lectures, presentations, and the like carried out using materials, there is a demand to provide static images of the materials to browsing clients together with video images, and synchronously reproduce these images for the purpose of enhancing the value of information to be provided.

Video contains many scenes. For video of the above-described lectures and the like, there is a demand to use materials to locate and reproduce the start of scenes in the video in which they were used. Locating the start of scenes is useful because the scenes to be viewed can be immediately located using the static images of representative portions in the video.

### SUMMARY OF THE INVENTION

The present invention has been made in view of the above circumstances and aims at synchronously reproducing video data and static image data associated therewith.

Other features and advantages of the present invention will be apparent from the following description.

The present invention is embodied in various forms such as an image reproduction system, an image reproduction method, and recording media storing a program for achieving the same by a computer. In any of the forms, video data and static image data are reproduced synchronously with each other.

An image reproduction system of the present invention includes a position information obtainment unit that obtains reproduction time positions of video data as the video data is reproduced, an image obtainment unit that obtains static image data associated in advance with the obtained reproduction time positions, and an image reproduction unit that reproduces the obtained static image data synchronously with the video data.

In a system that includes a delivery server holding video data and static image data associated with the video data, and browsing clients that reproduce video data and static image data provided from the delivery server and display them on a screen, the above-described functional units may be provided in the browsing clients, which request necessary static image data and reproduce static image data provided from the delivery server synchronously with the video data.

Therefore, in any of the above-described system configurations, specified static image data such as materials is reproduced synchronously with video reproduction.

Any of the above-described systems may be configured so that reproduction time position information of video data is accepted by user input, video data is reproduced from time positions based on the information, and static image data is reproduced synchronously with the video data.

Therefore, for example, when the user specifies time scale of a video player or elapsed time, according to the specification, video data can be midway reproduced from specified positions to reproduce corresponding static image data.

Static images associated with video data are presented to the user, and according to user specification for selecting the static images, the video data may be midway reproduced from reproduction time positions corresponding to the selected static images. Thereby, video data can be midway reproduced from user-specified time positions synchronously with static image data.

Although the above system may have individual functions configured as dedicated devices, it can be implemented by having a computer execute a program stored in recording media according to the present invention.

A method according to the present invention is implemented by the above system, for example.

### BRIEF DESCRIPTION OF THE DRAWINGS

Preferred embodiments of the present invention will be described in detail based on the followings, wherein:

FIG. 1 is a diagram showing the configuration of a system according to the present invention;

FIGS. 2A and 2B are diagrams for explaining a relationship between video data and image data according to an embodiment of the present invention;

FIG. 3 is a diagram showing a screen display of a browsing client according to an embodiment of the present invention;

FIG. 4 is a diagram showing a screen display of the browsing client according to an embodiment of the present invention;

FIG. 5 is a diagram showing a screen display of the browsing client according to an embodiment of the present invention;

FIG. 6 is a diagram showing a screen display of the browsing client according to an embodiment of the present invention;

FIG. 7 is a diagram showing a screen display of the browsing client according to an embodiment of the present invention;

FIG. 8 is a diagram for explaining a delivery server according to an embodiment of the present invention;

FIG. 9 is a diagram for explaining a procedure of contents data disposition and registration processing according to an embodiment of the present invention;

FIG. 10 is a diagram for explaining a relationship between a browsing client and a delivery server of synchronous reproduction processing according to an embodiment of the present invention;

FIG. 11 is a diagram for explaining a procedure of synchronous processing according to an embodiment of the present invention; and

FIG. 12 is a diagram for explaining Web functions of a browsing client according to an embodiment of the present invention;

### DESCRIPTION OF THE PREFERRED EMBODIMENTS

The present invention will be concretely described on the basis of preferred embodiments.

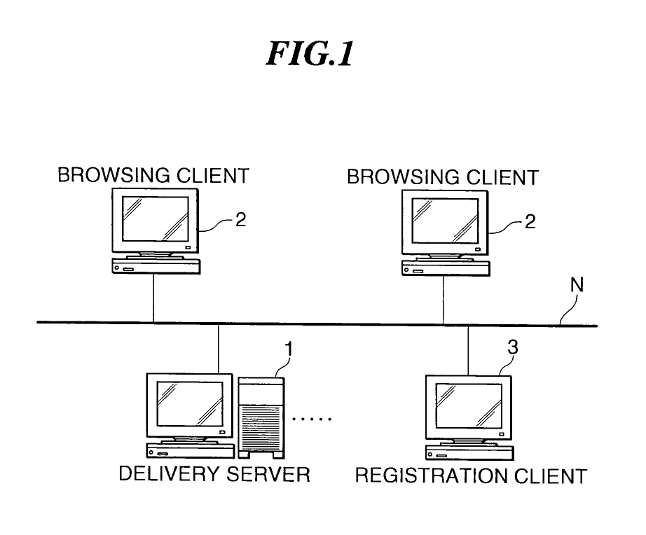

FIG. 1 shows a contents delivery system to which the present invention is applied. The system includes a delivery server 1, browsing clients 2, and a registration client 3, which are connected through the Internet N. The present invention is primarily applied to the browsing clients 2.

The delivery server 1, browsing clients 2, and registration client 3 each are configured to perform predetermined processing by executing a program according to the present invention by computer hardware. Especially, the browsing clients 2 are configured by the personal computer having a browser function for browsing contents.

The delivery server 1 stores the following data for each of contents: video data, static image data such as slide image data and material image data associated with the video data, voice index data for retrieval, and contents records (the meta-data) such as contents title. In response to a request from the browsing clients 2, the delivery server 1 delivers relevant contents data.

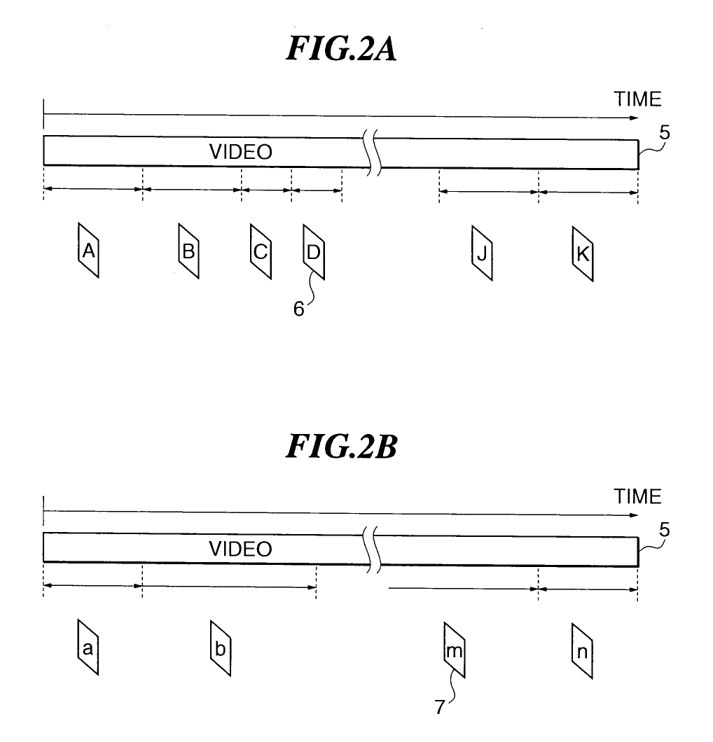

FIG. 2A shows correspondences between video data 5 and slide image data 6, and FIG. 2B shows correspondences between video data 5 and material image data 7.

Only one of the slide image data 6 and the material image data 7 may be associated with the video data 5. In the description of this specification, unless otherwise noted, both or one of the slide image data 6 and the material image data 7 may be described as image data.

In this example, although static image data obtained for reproduction from the delivery server 1 synchronously with the reproduction of video data is designated as the material image data 7, in the present invention, the same may apply to the slide image data 6 as well.

The video data 5 is moving image data transformed to a stream format for delivery. The slide image data 6 (A to K) is static image data extracted by automatic processing or operator operation from the video data 5 by preprocessing before disposition registration. These pieces of slide image data are scenes images representatively representing scenes having a certain time width in the video, and are associated with corresponding scenes of the video data 5.

The slide image data is primarily used for retrieval by which browsing users search for desired contents or search for desired scenes in contents video.

The material image data 7 (a to n) is static image data associated with the video data 5 by an operator who performs setting operations while viewing video in preprocessing before disposition registration. For example, the video data 5 is the product of the photographing of presentation, lecture, and the like, while the static image data is the product of the photographing of materials used in the presentation. The material image data 7 is associated with scenes having a certain time width in video in which a material was used; as described in detail later, synchronously with video image data, corresponding material image data is reproduced and presented to browsing users.

Contents data such as the video data 5, and the static image data 6 and 7, in response to a request from the browsing clients 2 using the browser, is delivered by the delivery client 1, offered to the requesting browsing clients 2, and displayed on a screen of their display unit.

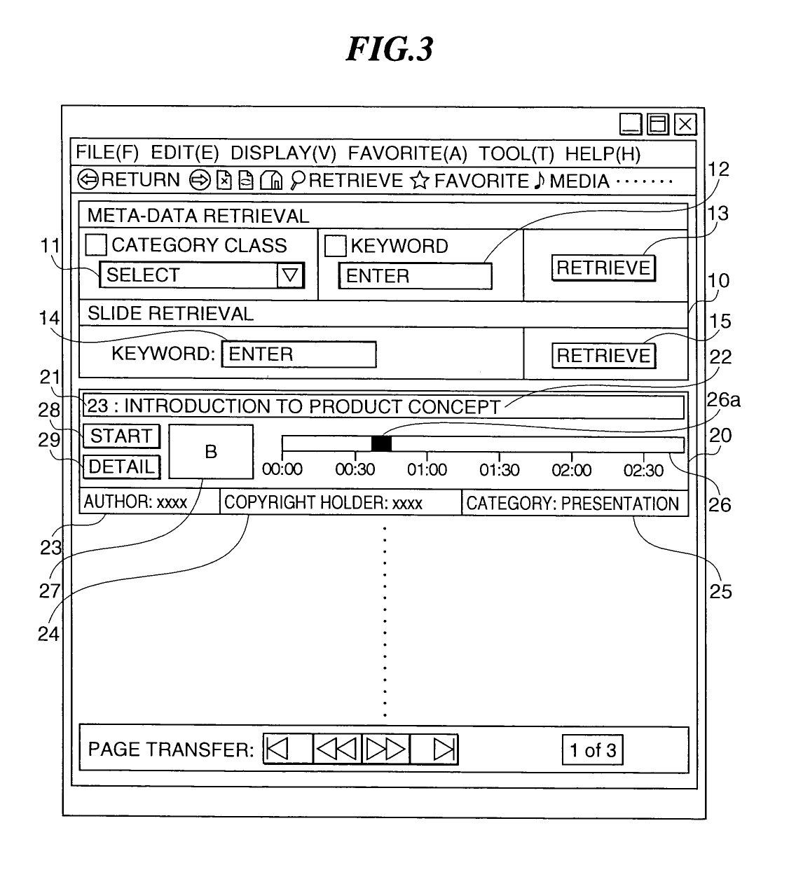

FIG. 3 shows a list of contents displayed as a default screen in the browsing clients 2 that have accessed the delivery server 1 by a proper URL. The contents list screen includes a retrieval interface 10 and plural contents interfaces 20, one for each contents. Browsing users can retrieve desired contents from registered contents by entering commands to the retrieval interface 10 by key entry or pointing input, and display and browse descriptions of the contents data on the screen by entering commands to the contents interfaces 20 by pointing input.

The retrieval interface 10 performs retrieval by use of meta-data and voice index data registered in the delivery server 1 in association with individual contents data. It is provided with: a drop-down window part 11 for selecting and inputting categories; a keyword input part 12 for retrieving desired contents data; a retrieval button 13 for requesting the delivery server 1 to perform retrieval processing and offer retrieval results, based on inputs from these parts; a keyword input part 14 for retrieving desired contents data by use of voice index data; and a retrieval button 15 for requesting the delivery server 1 to perform retrieval processing and offer retrieval results, based on the input.

The voice index data registered in the delivery server 1 in association with contents data is voice waveform data contained in the contents. The delivery server 1 converts a keyword input from the keyword input part 14 into voice waveform data and compares these pieces of waveform data to retrieve contents containing the input keyword.

The contents interfaces 20 display: a contents number 21 based on the meta-data; a contents title 22; a contents author 23; a contents copyright holder 24; a contents category 25; a contents video time scale 26; and a slide image 27 of the contents video. A function of presenting the time scale 26 can change slide image data (A to K) 6 displayed as slide images 27 as a plug 26a is moved by user operations, and reproduce slide images in accordance with reproduction time positions of the video data.

The contents interfaces 20 are provided with a start button 28 and a detail button 29. When a user presses the start button 28, relevant contents video data can be reproduced and displayed on the screen of the browsing clients 2 after being obtained from the delivery server 1. When the user presses the detail button 29, as described later, data of slide images and material images of relevant contents can be displayed on the screen of the browsing clients 2 after being collectively obtained from the delivery server 1.

In this way, in the case where the video data 5 and all static image data associated with it are provided to the browsing clients 2, when the user specifies the slide images 27 and material images 30 that are displayed, by a pointing operation, video data is reproduced from corresponding scenes (that is, reproduction time positions) and displayed on the screen. This function is provided for the browsing clients 2.

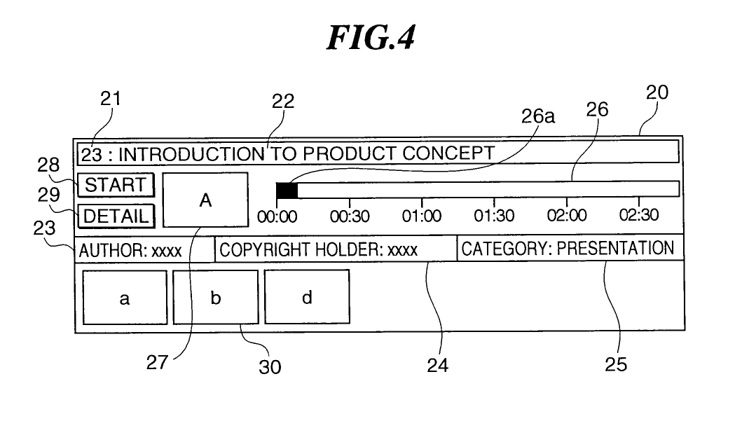

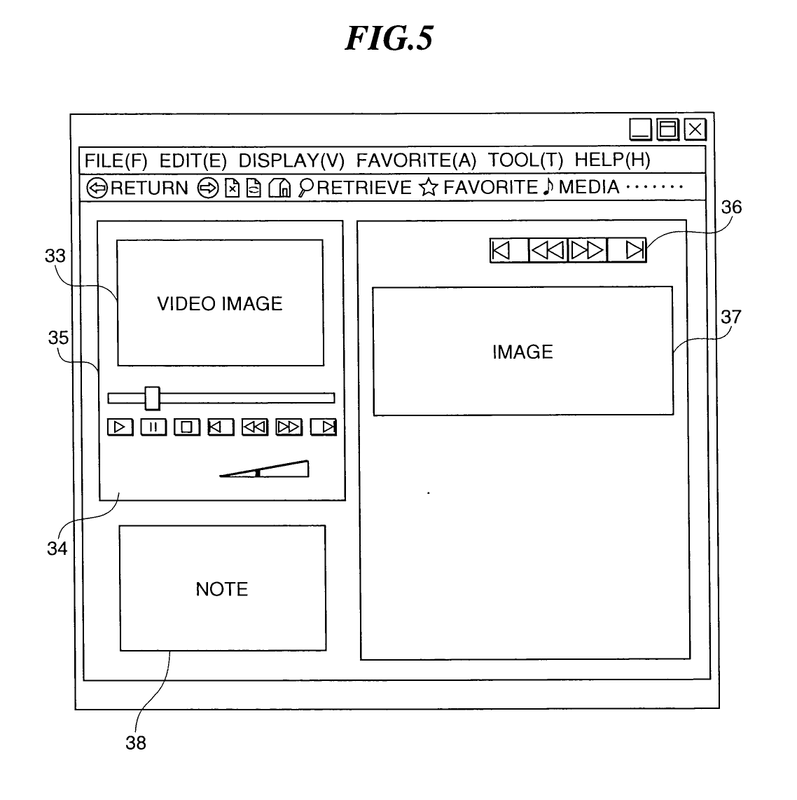

Contents stored in association with material screen data can be subjected to keyword retrieval based on relevant material image data, and the contents interface 20 as shown in FIG. 4 is displayed as a result of the retrieval.

The contents interface 20 is almost the same as those in FIG. 3. By matching character strings contained in the material images 30 with an input keyword, a list of relevant material images 30 is displayed, and when the user specifies the displayed material images 30 by a pointing operation, contents video data is reproduced synchronously from corresponding scenes and displayed on the screen. This function is also provided for the browsing clients 2.

By the above user operations, the delivery server 1 is accessed and desired contents data is delivered to the browsing clients 2. The delivered contents data is displayed as a contents browsing screen by the browsing clients 2 as shown in FIG. 5. The contents browsing screen includes: a video screen 33 for displaying reproduced video images; a video player part 35 having a video operation part 34 provided with reproduction, stop, and other operation buttons; an image display part 37 for reproducing and displaying static image data wherein it has an operation part 36 provided with an operation button for advancing frames; and a note display screen part 38 for displaying a program description about contents data, and the like.

Therefore, the browsing user can, by performing operations by pointing input, can display video images on the video screen 33 and synchronously display material images (or slide images) corresponding to reproduction time positions of video data on the image display part 37.

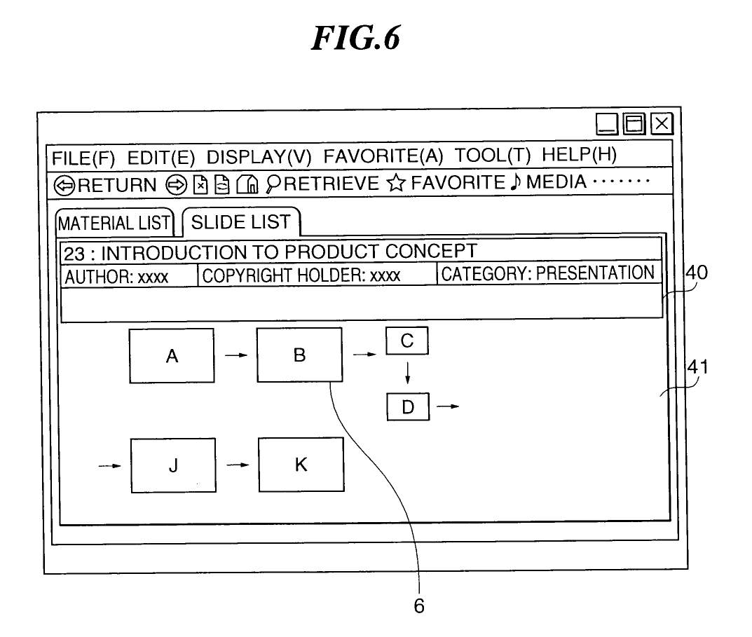

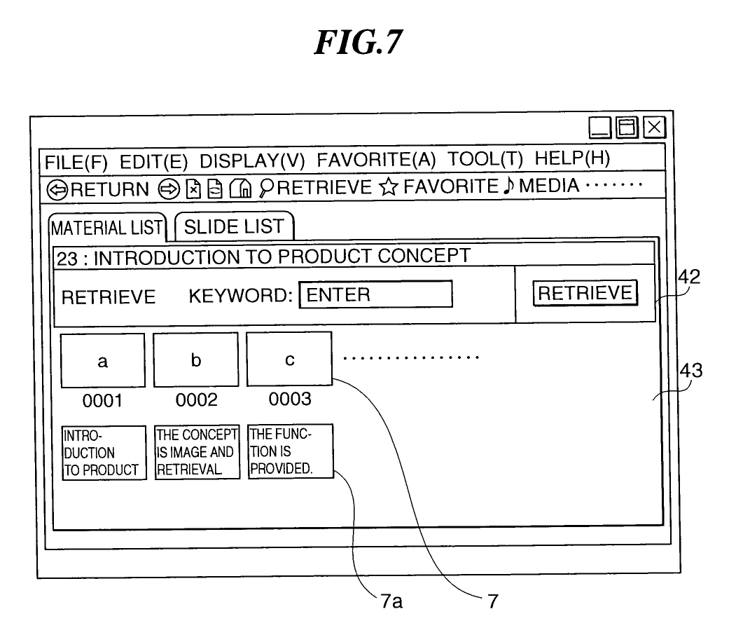

By pressing the detail button 29, the delivery server 1 is accessed and image data of desired contents is collectively delivered to the browsing clients 2. The delivered image data is displayed as a detailed display screen as shown in FIG. 6 or 7 in the browsing clients 2.

FIG. 6 shows a list image display of the slide image data 6 wherein various items of meta-data of relevant contents are displayed in a record data display part 40 and all slide images 6 associated with the relevant contents are displayed in time series in a slide image display part 41.

The slide images 6 are displayed in the slide image display part 41 so as to enlarge according to the time length of corresponding scenes. For example, as shown in FIG. 2A, slide images 6 such as C and D shorter in scene length than other slide images are displayed in smaller sizes other than the other slide images in the slide image display part 41. Such size change can be made in the delivery server 1 according to a detail display request, for example, by appending information about scene length to the slide images.

The sizes of display images may be changed according to the magnitude of changes in scene contents, author's intention, or the importance of scenes.

FIG. 7 shows a list image display of the material image data 7 wherein various items of meta-data of relevant contents are displayed in a record data display part 42, and all time-series material images 7 associated with the relevant contents, and descriptive character strings 7a extracted from the material images 7 are displayed in a material screen display part 43. The character strings 7a are extracted from the material image data 6 by character recognition processing and the like as required, and are matched when the material images are to be retrieved by keyword as described above.

As shown in FIGS. 6 and 7, for displayed slide images and material images, when the user selects any of the static images by a pointing operation, the video player 35 is displayed on the screen, and video data can be reproduced from corresponding time positions and displayed on the screen.

Next, a description will be made of processing for registering the video data 5, image data, and the like in the delivery server 1 in association with each other.

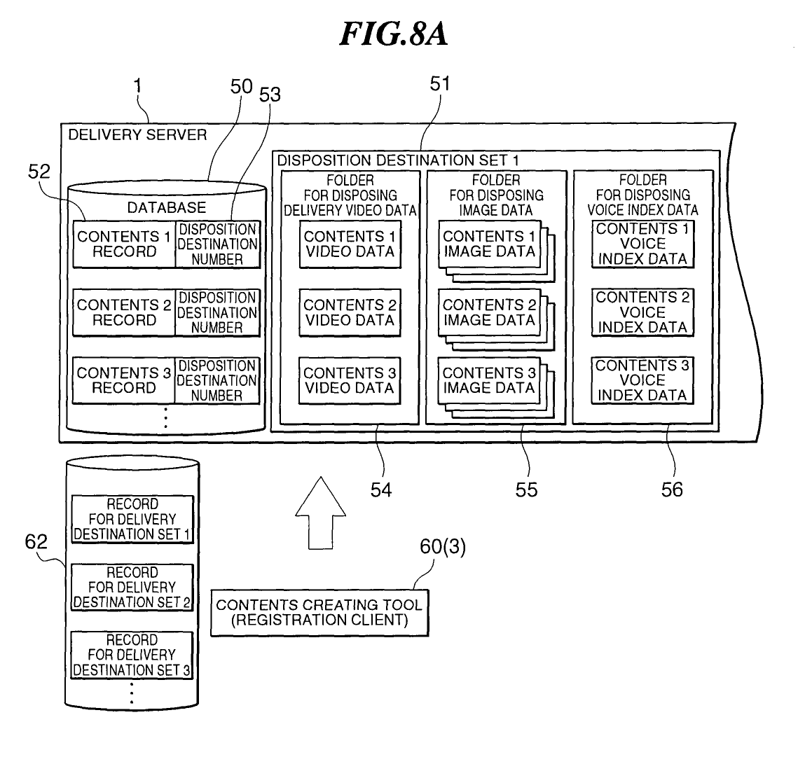

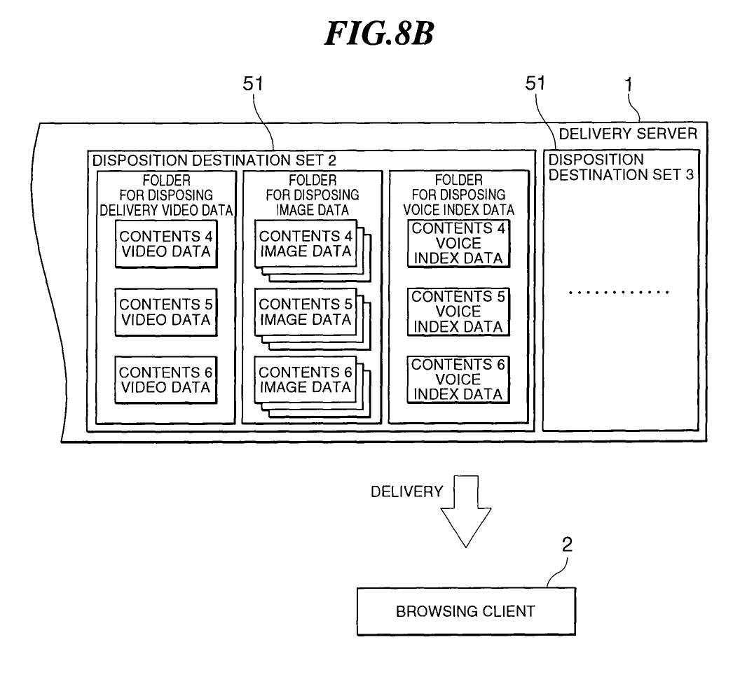

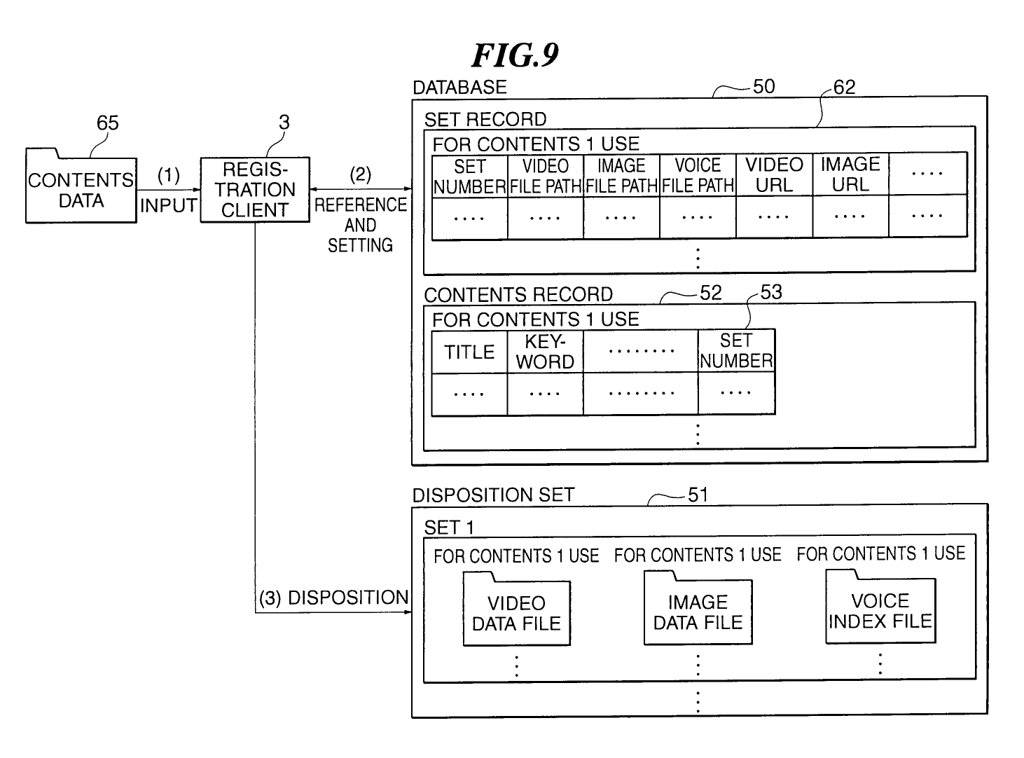

As shown in FIG. 8, a disposition server 1 is provided with a database 50 storing and managing records of disposed and registered contents, and disposition destination sets 51 storing the entities of contents data.

The database 50 stores and manages contents records 52 containing meta-data of contents data, disposition destination file path, disposition destination URL, and the like, as well as numbers 53 for locating disposition destination sets in which the contents data is disposed and registered. By consulting the database 50, contents data can be disposed and registered in a folder within the disposition sets 51, and specified contents data requested from the browsing clients 2 can be delivered.

Each of the disposition destination sets 51 is a storage area storing one or plural pieces of contents data, and a contents data storage area of the disposition server 1 is formed as a collection of the disposition destination sets 51.

In the shown example, each disposition destination set 51 is provided with a video data folder 54 storing video data, an image data folder 55 for storing image data, and a voice index folder 56 for storing voice index data. Corresponding data of each contents is registered and stored in the folders 54 to 56 so that data of same contents is stored in one disposition destination set 51.

Contents data is disposed and registered in the disposition destination sets 51 by a contents creation tool 60 possessed by the registration client 3 according to operator operations.

The contents creation tool 60 performs: converting video data of MPEG or other formats into video data of stream format for delivery; registering converted video data; registering the video data 5 in association with the image data 6; registering the video data 5 in association with the material image data 7; and registering the video data 5 in association with voice index data.

Disposition and registration of contents data (video data, image data, voice index data) is started by inputting the contents data 65 to be registered to the registration client 3 ((1)) and connecting the registration client 3 to the delivery server 1.

The registration client 3 consults a set record 62 from the database 50, sets a disposition destination set number of the contents data of an archive file, file paths of individual media data, and URLs of individual media data ((2)), and transmits the contents data to the delivery server 1 to register it ((3)).

At this time, meta-data input by the operator as described above is also set in the contents record 52, and the contents record 52 and the set record 62 are associated by a disposition destination set number.

Contents data thus registered and disposed is provided from the delivery server 1 by consulting the database 50 according to a request from the browsing clients 2.

Specifically, when the browsing clients 2 transmit a request containing information specifying contents to the delivery server 1, the delivery server 1 consults the contents records 52 to locate a disposition destination set number in which the contents data is disposed, consults a set record 62 from the disposition destination set number to locate the URL of relevant video data and its image data, and transmits it to the browsing clients 2. The browsing clients 2 accesses the contents data file, based on the URL provided from the delivery server 1, obtains the relevant video data and image data, and displays them on the screen.

Next, a description will be made in detail of processing in which the browsing clients 2 obtain and synchronously reproduce corresponding static image data (material image data) from the delivery server 1, synchronously with the reproduction of video data.

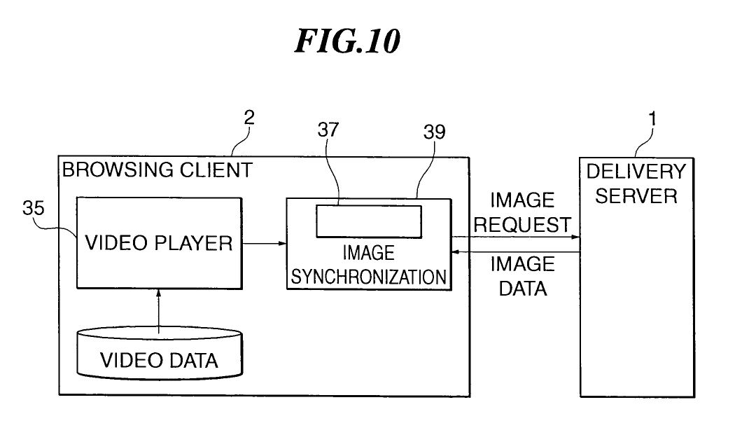

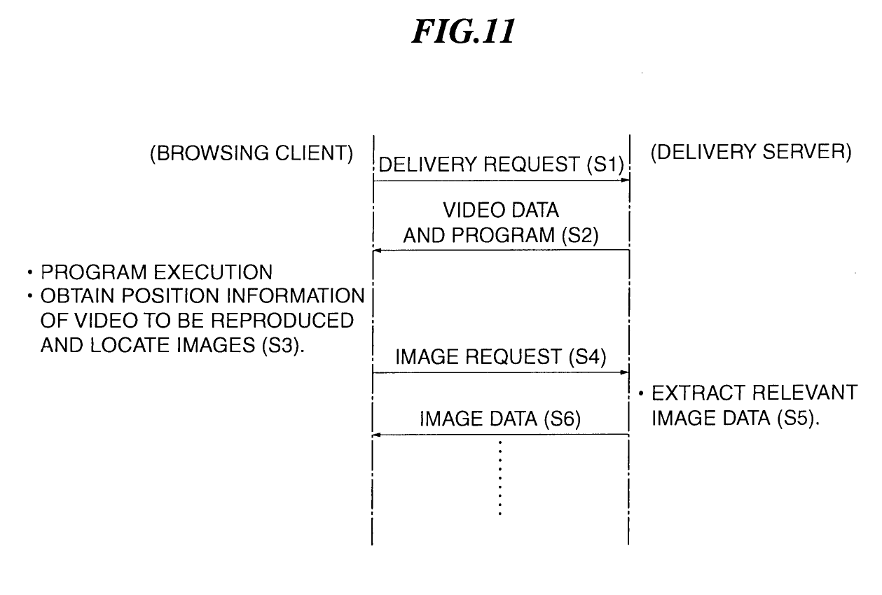

The synchronous reproduction processing is performed according to a procedure shown in FIG. 11 under cooperation between the delivery server 1 and the browsing client 2 as shown in FIG. 10.

First, as described above, the browsing clients 2 connect to the delivery server 1 and request desired contents (step S1). The delivery server 1 provides relevant video data and a program for obtaining static image data associated synchronously with the video data from the delivery server 1 to the browsing clients 2 (step S2).

The browsing clients 2 reproduce the provided video data by the video player 35 and displays it on a screen, and starts an image synchronization function 39 for executing the provided program to obtain reproduction time positions of the reproduced video data and locate static image data to be displayed (step S3).

The browsing clients 2 make a request to the delivery server 1 for necessary static image data (step S4), and the delivery server 1 provides the requested image data to the browsing clients 2 (step S6). The provided image data is immediately reproduced and displayed on the image display part 37. Processing of the steps S3 to S6 is repeatedly performed in the course of the video data reproduction, and corresponding static image data is displayed one after another synchronously with reproduction time positions of reproduced video data, as shown in FIG. 5.

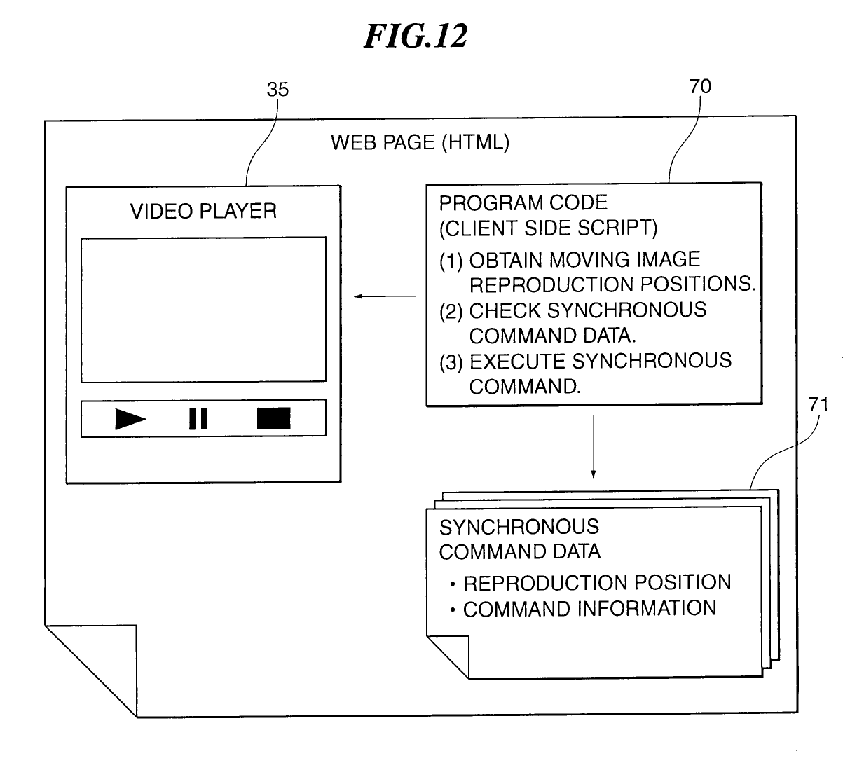

To be more specific, a Web page in FIG. 12 displayed by a Web browser of the browsing clients 2 contains the video player part 35 as shown in FIG. 5, as well as the above-described program provided from the delivery server 1. The program contains program code 70 and plural pieces of synchronous command data 71.

The program code 70 contains: a moving image reproduction position obtainment program for obtaining reproduction time position information of reproduced video data; a synchronous command data check program for checking the synchronous command data 71; and a synchronous command execution program for executing a command corresponding to the synchronous command data 71.

The synchronous command data 71 contains information about video data reproduction time as command execution time, and information about a command to be executed. The synchronous command data 71 exists for each of plural static image data pieces associated with video data, and contains reproduction time position information indicating a position in which a relevant static image data is associated with video data, and a command that makes a request to the delivery server 1 for the static image data in the reproduction time position.

Therefore, the program code 70 is executed synchronously with the reproduction of video data by the video player; the moving image reproduction position obtainment program obtains reproduction time position information of reproduced video data; the synchronous command data check program determines whether the obtained reproduction time position exists in the synchronous command data 71; and if it exists, the command execution program executes a command of the synchronous command data to make a request to the delivery server 1 for relevant static image data. This processing is repeatedly performed in the course of video data reproduction.

Although a description has been made of a system in which the browsing clients 2 reproduce data delivered from the delivery server 1, an image reproduction system of the present invention may be of a standalone system configuration in which video data and static image data associated therewith are held; where such a configuration is employed, relevant static image data can be obtained within the system, and reproduced synchronously with the video data.

As has been described above, according to the present invention, since video image data and static image data associated in advance with reproduction time positions of the video image data are reproduced synchronously with each other, significant image information can be presented to browsing users, and the retrieval of required image information and video scenes can be easily performed.

The entire disclosure of Japanese Patent Application No. 2002-272499 filed on Sep. 19, 2002 including specification, claims, drawings and abstract is incorporated herein by reference in its entirety.

What is claimed is:

1. An image reproduction system that reproduces static image data synchronously with reproduction of video data, comprising:
a position information obtainment unit that obtains a reproduction time position of the video data as the video data is reproduced;
an image obtainment unit that obtains static image data associated in advance with the obtained reproduction time position; and
an image reproduction unit that reproduces the obtained static image data synchronously with the video data.

2. An image reproduction system that reproduces static image data synchronously with reproduction of video data, comprising:
a delivery server that holds the video data and static image data associated with the video data; and
a browsing client that reproduces and displays on a screen the video data and static image data provided by the delivery server,
wherein the browsing client comprises:
a position information obtainment unit that obtains a reproduction time position of the video data as the video data is reproduced;
an image request unit that makes a request to the delivery server for static image data associated in advance with the reproduction time position; and
an image reproduction unit that reproduces the static image data synchronously with the video data, the static image data being provided by the delivery server in response to the request.

3. The image reproduction system according to claim 1, further comprising:
a specification unit that accepts reproduction time position information of the video data from a user's input; and
a video reproduction unit that reproduces the video data from a time position corresponding to the accepted reproduction time position information,
wherein the position information obtainment unit obtains time position information specified by the user's input.

4. An image reproduction system that reproduces video data and plural pieces of static image data in association with each other, comprising:
a specification unit that accepts a command provided by a user's input to select one piece of static image data from the static image data pieces; and
a video reproduction unit that reproduces the video data from a reproduction time position with which the selected piece of static image data is associated.

5. An image reproduction method that reproduces static image data synchronously with reproduction of video data, comprising the steps of:
obtaining a reproduction time position of the video data as the video data is reproduced; obtaining static image data associated in advance with the obtained reproduction time position; and
reproducing the obtained static image data synchronously with the video data.

6. An image reproduction method that reproduces static image data synchronously with reproduction of video data, comprising the steps of:
obtaining a reproduction time position of the video data as the video data is reproduced; requesting static image data associated in advance with the obtained reproduction time position from a delivery server holding the static image data associated with the video data; and
reproducing the static image data provided by the delivery server synchronously with the video data.

7. An image reproduction method that synchronously reproduces video data and static image data, comprising the steps of:
associating the static image data in advance with a reproduction time position of the video data;
accepting reproduction time position information of the video data from a user's input;
reproducing the video data from a reproduction time position included in the accepted reproduction time position information; and
reproducing static image data associated with the reproduction time position included in the accepted reproduction time position information.

8. An image reproduction method that synchronously reproduces video data and static image data, comprising the steps of:
associating the static image data in advance with a reproduction time position of the video data;
accepting a user's input for selecting a static image displayed on a screen; and
reproducing the video data from the reproduction time position with which data of the selected static image is associated.

9. A storage medium readable by a computer, the storage medium storing a program of instructions executable by the computer to perform a function for reproducing static image data synchronously with reproduction of video data, the function comprising the steps of:
obtaining a reproduction time position of the video data as the video data is reproduced;
obtaining the static image data associated in advance with the obtained reproduction time position; and
reproducing the obtained static image data synchronously with the video data.

10. A storage medium readable by a computer, the storage medium storing a program of instructions executable by the computer to perform a function for reproducing static image data synchronously with reproduction of video data, the function comprising the steps of:
obtaining a reproduction time position of the video data as the video data is reproduced;
requesting the static image data associated in advance with the obtained reproduction time position from a delivery server holding the static image data associated with the video data; and
reproducing the static image data provided by the delivery server synchronously with the video data.

11. A storage medium readable by a computer, the storage medium storing a program of instructions executable by the computer to perform a function for reproducing static image data synchronously with reproduction of video data, the function comprising the steps of:
accepting reproduction time position information of the video data from a user's input;
reproducing the video data from a reproduction time position included in the accepted reproduction time position information; and
reproducing static image data associated with the reproduction time position included in the accepted reproduction time position information.

12. A storage medium readable by a computer, the storage medium storing a program of instructions executable by the computer to perform a function for reproducing static image data synchronously with reproduction of video data, the function comprising the steps of:
accepting a user's input for selecting a static image displayed on a screen; and
reproducing the video data from a reproduction time position with which data of the selected static image is associated in advance.
